(19) United States
(12) Patent Application Publication
(10) Pub. No.: US 2002/0170028 A1
(43) Pub. Date: Nov. 14, 2002

(54) Computer-aided layout design system with automatic defect-zooming function

(76) Inventor: Liwei Chour, HsinChu City (TW)

Correspondence Address: BIRCH STEWART KOLASCH & BIRCH, PO BOX 747, FALLS CHURCH, VA, 22040-0747, US

(21) Appl. No.: 09/852,707

(22) Filed: May 11, 2001

(51) Int. Cl. G06G 7/48

(52) U.S. Cl. 716/11

(57) ABSTRACT

A computer-aided layout design system according to the invention at least includes a defect-detecting module and a zoom-lens module. The defect-detecting module detects at least one defect of the layout. The zoom-lens module generates an enlarged image of the defect, and displays the enlarged image simultaneously with the layout image.

### BACKGROUND OF THE INVENTION

1. Field of the Invention

The invention relates to a computer-aided layout design system. More specifically, it relates to a computer-aided layout design system, which can detect and enlarge the image of the defects in an layout automatically.

2. Related Art

Generally speaking, along with the fast development in computer technology, the IC layout becomes more and more huge and complicated. Therefore, after finishing a layout, it is very important for a layout design engineer to perform a design rule check. The design rule check is to check the layout to see if it conforms to the basic electrical properties. For example, if the output pin is connected to the power supply, or if the output pin is connected to the input pin, then the layout is not conforms to the basic electrical properties. Except to the electrical property check, the design rule check also includes inspection for duplicate elements or incorrect element serial numbers.

In a state-of-the-art computer-aided layout design system, it is common to have a defect-detection function to detect the defects automatically in a huge and complex layout. After defect detection, the result is recorded in a text file. When there exists any defect, the detail description of the defect, e.g., the name, coordinate or reason of the defect, will be recorded in the text file. Moreover, as illustrated in FIG. 1, a warning sign may be placed directly at the position of the defect 2, so that the engineer can discover the defect 2 of the layout 200 more easily.

However, since a layout is usually very complicated, engineers usually have trouble discovering the defects of the layout. Firstly, the engineer must enlarge the portion of defect of the layout to investigate the defect more clearly, but in a complex layout, it is often difficult to find out the exact position of the defect. The engineer must perform the zoom-in function several times carefully. Secondly, to enlarge the whole complex layout needs a lot of time, which lowers the working efficiency of the engineers. Thirdly, if the layout includes many layers, then it is usually not convenient for the engineers to investigate a specific layer of the layout.

### SUMMARY OF THE INVENTION

In view of the above, an objective of the invention is to provide a computer-aided layout design system, which can detect and enlarge the defect portion of a layout automatically.

Another objective of the invention is to provide a computer-aided layout design system, which does not enlarge the whole layout while enlarging the defect portion of the layout.

To achieve the above objectives, the computer-aided layout design system according to the invention at least includes a defect-detecting module and a zoom-lens module. The defect-detecting module detects at least one defect of the layout. The zoom-lens module generates an enlarged image of the defect, and displays the enlarged image simultaneously with the layout image.

According to one aspect to the invention, the layout comprises at least two layers, and the zoom-lens module generates the enlarged image of at least one specific layer among the layers.

According to another aspect of the invention, the zoom-lens module adjusts an enlarge ratio of the enlarged image relative to the layout image automatically.

According to still another aspect of the invention, the layout has at least two defects, and the zoom-lens module is able to switch between the defects to generate the enlarged images of the defects respectively.

According to still another aspect of the invention, the system further comprises an information-display module, which displays information with respect to the defect while the enlarged image is displaying.

The invention also provides a computer-aided layout design method, which firstly displays a layout image of at least a portion of a layout, and detects at least one defect of the layout. Then, the method generates an enlarged image of the defect, and displays the enlarged image simultaneously with the layout image.

### BRIEF DESCRIPTION OF THE DRAWINGS

FIG. 1 is a schematic view showing the condition of a warning sign being placed on the defect in a layout image.

FIG. 2 is a schematic view showing the configuration of the computer-aided layout design system according to the preferred embodiment of the present invention.

FIG. 3 is a schematic view showing a display example of the computer-aided layout design system according to the preferred embodiment of the present invention.

FIG. 4 is a schematic view showing another display example of the computer-aided layout design system according to the preferred embodiment of the present invention.

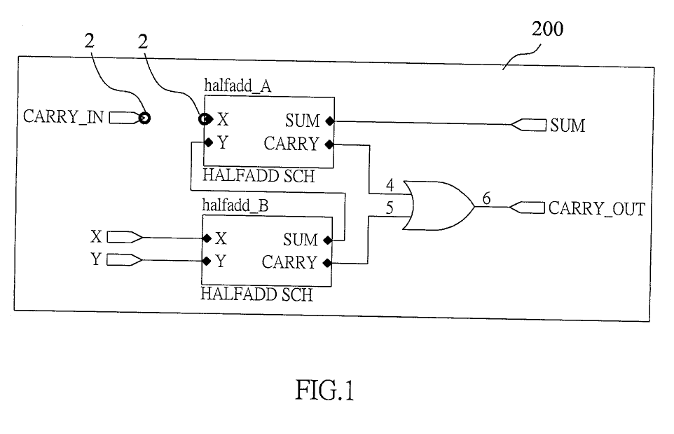

### DETAILED DESCRIPTION OF THE PREFERRED EMBODIMENT

The computer-aided layout design system of the invention will be apparent from the following detailed description, which proceeds with reference to the accompanying drawings, wherein the same references relate to the same elements.

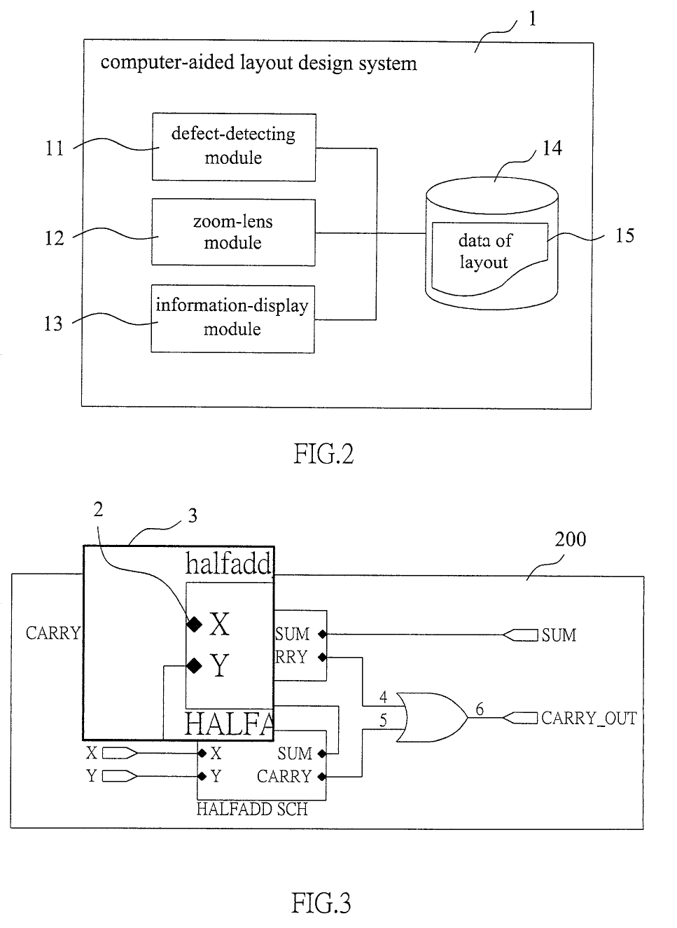

Referring to FIG. 2, the computer-aided layout design system 1 according to the preferred embodiment of the invention is for designing an IC layout, and includes a defect-detecting module 11, a zoom-lens module 12, a information-display module 13 and a storage device 14. The defect-detecting module 11 detects at least one defect of the layout, and the zoom-lens module 12 generates an enlarged image of the defect and displays the enlarged image simultaneously with the image of the layout. Information-display module 13 displays an information window containing information with respect to the defect while the enlarged image is displaying. Storage device 14 stores data of the layout 15, which is read and processed by the above-mentioned modules for defect detecting, enlarged image generation and information window displaying.

Referring to FIG. 3, when a component has a defect 2 of lacking of connection lines between the component and other components, the zoom-lens module 12 generates an enlarged image 3 of this defect 2, so that a design engineer can have a clear view of this defect 2. It should be noted that the layout image and the enlarged image 3 are displayed to the engineer at the same time, and the engineer can investigate the portion of the defect 2 and other portion of the layout simultaneously. This facilitates the engineer's debug process when the electric properties between the portion of the defect 2 and other portions of the layout are important.

In the preferred embodiment, the enlarged image 3 can be displayed at different enlarge ratio. The enlarge ratio may be determined either by the engineer according to his or her preference, or by the system automatically. For example, when the circuit design of portion of defect 2 is complex, the zoom-lens module 12 may use a larger enlarge ratio so that the engineer can see the portion of defect 2 more clearly. On the other hand, when the circuit design of portion of defect 2 is simple, the zoom-lens module 12 may use a smaller enlarge ratio so that the engineer can see more wires and components of the portion of defect 2.

In the preferred embodiment, if the layout has a plurality of defects, the zoom-lens module 12 can switch between the defects, and generate the enlarged image 3 of each portion of defect 2. This facilitates the engineer to inspect a plurality of defects, since the engineer does not have to find the position of the defects manually.

In the preferred embodiment, if the layout comprises a plurality of layers, the zoom-lens module 12 can display only some specific layers of the layout. The zoom-lens module 12 may allow the engineer to select at least one specific layer among the layers of the layout, and display only the specific layer. On the other hand, the zoom-lens module 12 may select the layer including the defect as the specific layer automatically. To display only the specific layer or layers facilitates the debug process when the wires and components of the layers are overlapped with each other. For example, if the layout includes four layers, and the defect exists on the third layer, then the zoom-lens module 12 can display only the third layer, so that the engineer can see the defect more clearly.

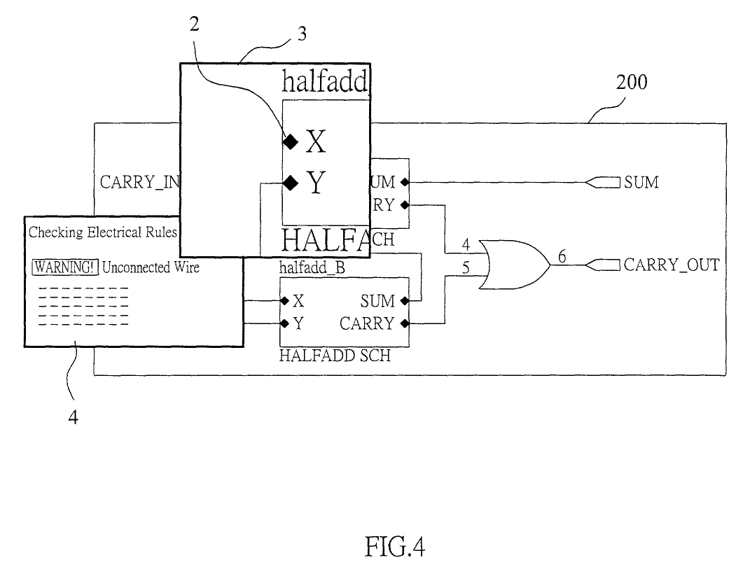

In the preferred embodiment, an information-display module displays information with respect to the defect while the zoom-lens module 12 displays the enlarged image 3. Referring to FIG. 4, for example, after the defect-detecting module 11 detected a defect, while the zoom-lens module 12 displays the enlarged image 3, the information-display module displays an information window 4 besides the enlarged image 3. The information window 4 shows the type of the defect and other related information, which might be helpful for engineers to analyze the defect 2.

In the preferred embodiment, the layout is divided into a plurality of subdivisions by, for example, a quad-tree algorithm, and the zoom-lens module 12 may process only a subdivision of the layout. Since the zoom-lens module 12 does not have to process the whole layout while generating the enlarged image 3, the process speed and memory-management efficiency can be increased significantly.

The computer-aided layout design system according to the invention can detect and enlarge the defect portion of a layout automatically. Therefore, the working efficiency of the engineers can be increased.

The computer-aided layout design system according to the invention can investigate a specific layer of a layout if the layout includes many layers. Therefore, it is very convenient for the engineers to further investigate the defect of the layout.

Certain variations would be apparent to those skilled in the art, which variations are considered within the spirit and scope of the claimed invention.

What is claimed is:

1. A computer-aided layout design system, for designing a layout image of at least a portion of a layout, comprising:
a defect-detecting module, which detects at least one defect of the layout; and
a zoom-lens module, which generates an enlarged image of the defect, and displays the enlarged image simultaneously with the layout image.

2. The computer-aided layout design system of claim 1, wherein:
the layout comprises at least two layers; and
the zoom-lens module generates the enlarged image of at least one specific layer among the layers.

3. The computer-aided layout design system of claim 1, wherein:
the zoom-lens module adjusts an enlarge ratio of the enlarged image relative to the layout image automatically.

4. The computer-aided layout design system of claim 1, wherein:
the layout has at least two defects; and
the zoom-lens module is able to switch between the defects, and generates the enlarged images of the defects.

5. The computer-aided layout design system of claim 1, further comprising:
an information-display module, which displays information with respect to the defect while the enlarged image is displaying.

6. A computer-aided layout design method, comprising:
displaying a layout image of at least a portion of a layout;
detecting at least one defect of the layout; and
generating an enlarged image of the defect, and displaying the enlarged image simultaneously with the layout image.

7. The computer-aided layout design method of claim 6, wherein:
the layout comprises at least two layers; and
the generating step further generates the enlarged image of at least one specific layer among the layers..

8. The computer-aided layout design method of claim 6, wherein:
the generating step further adjusts an enlarge ratio of the enlarged image relative to the layout image automatically.

9. The computer-aided layout design method of claim 6, wherein:
the layout has at least two defects; and
the generating step further switches between the defects, and generates the enlarged images of the defects respectively.

10. The computer-aided layout design method of claim 6, further comprising:
displaying information with respect to the defect while the enlarged image is displaying.
